(19) United States
(12) Patent Application Publication
(10) Pub. No.: US 2026/0313376 A1
(43) Pub. Date: Oct. 8, 2026

(54) AUTHORIZING A CONSUMER WHEN RESOLVING AN IP ADDRESS

(71) Applicant: InterDigital Patent Holdings, Inc., Wilmington, DE (US)

(72) Inventors: Zhibi Wang, Woodridge, IL (US); Michael Starsinic, Newtown, PA (US); Michel Roy, Candiac (CA); Samir Ferdi, Kirkland (CA); Taimoor Abbas, Sainte-Julie (CA)

(73) Assignee: InterDigital Patent Holdings, Inc., Wilmington, DE (US)

(21) Appl. No.: 19/483,591

(22) PCT Filed: May 9, 2024
(86) PCT No.: PCT/US2024/028569

§ 371 Date: Nov. 11, 2025

Related U.S. Application Data
(60) Provisional application No. 63/465,924, filed on May 12, 2023.

(51) Int. Cl. H04W 12/062; H04W 12/108

(52) U.S. Cl. CPC H04W 12/062; H04W 12/108

(57) ABSTRACT

Systems, methods, devices, and instrumentalities are described herein related to authorizing a consumer when resolving an IP address. A device, such as a binding support function (BSF), may include a processor configured to perform one or more actions. The device may receive a request for a wireless transmit/receive unit (WTRU) identifier. The request may include a provided hash value and an IP address. The device may determine a calculated hash value based on the IP address. The device may determine that the provided hash value and the calculated hash value are not equal. Upon determining that the hash values are different, the device may send a response including an indication that the requested WTRU identifier is not included in the response.

### CROSS-REFERENCE TO RELATED APPLICATIONS

This application claims the benefit of Provisional U.S. Patent Application No. 63/465,924, filed May 12, 2023, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein relating to authorizing a consumer when resolving an IP address.

Systems, methods, devices, and instrumentalities may be provided for hosting an edge enabler client (EEC). A security credential using an Internet Protocol (IP) address of the WTRU may be determined. A first message may be sent to a network node. The first message may indicate a request for a WTRU identifier, the security credential, and the IP address. A second message may be received from the network node. The second message may indicate the WTRU identifier based on the security credential.

Systems, methods, devices, and instrumentalities may provide a binding support function (BSF). A first message from a second network node may be received. The first message may indicate a request for a wireless transmit/receive unit (WTRU) identifier, a first security credential, and an IP address. A second security credential may be determined based on the IP address. The first message may be determined to be secure if the first security credential matches the second security credential. A second message may be sent to the second network node if the first message is secure. The second message may indicate the WTRU identifier, and a response associated with the request for the WTRU identifier.

A device (e.g., a binding support function (BSF)) may include a processor configured to perform one or more actions. The device may receive a request for a wireless transmit/receive unit (WTRU) identifier. The request may include a provided hash value and an IP address. The device may determine a calculated hash value based on the IP address. The device may determine that the provided hash value and the calculated hash value are not equal. The device may send a response including an indication that the requested WTRU identifier is not included in the response.

The indication may indicate that the requested wireless transmit/receive unit (WTRU) identifier may not be included in the response because the provided hash value is not equal to the calculated hash value.

The calculated hash value may be further based on one or more of a subscription permanent identifier (SUPI), a data network name (DDN), a single-network slice selection assistance information (S-NSSAI), or a credential.

A device (e.g., a wireless transmit/receive unit (WTRU) may be configured to host an edge enabler client (EEC). The device may include a processor configured to perform one or more actions. The device may determine a provided hash value based on an IP address of the device. For example, the device may send a request for a WTRU identifier that may include the provided hash value and the IP address. The device may receive a response. This response may include an indication that the requested WTRU identifier is not included in the response.

The indication may indicate that the requested WTRU identifier is not included in the response because the provided hash value does not equal a calculated hash value.

The provided hash value may be further based on one or more of the following: a subscription permanent identifier (SUPI), a data network name (DDN), a single-network slice selection assistance information (S-NSSAI), or a credential.

The processor of the device may be further configured to receive a first request to discover the WTRU identifier. The first request may be received from an application client.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example high-level architecture.

FIG. 3 illustrates an example of IP address verification.

FIG. 4 depicts an example of IP address verification that may use a shared credential between an EEC and an EES.

### DETAILED DESCRIPTION

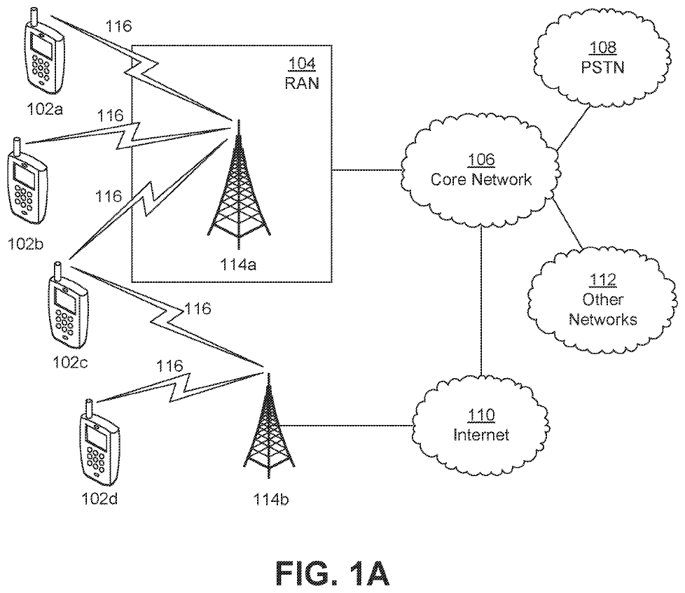

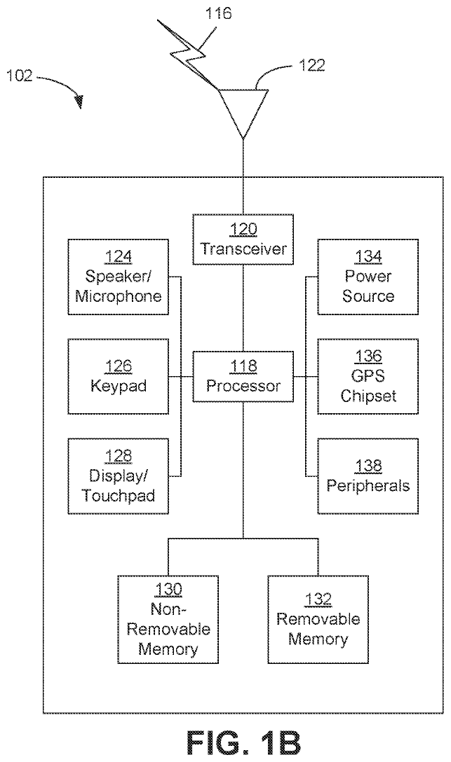

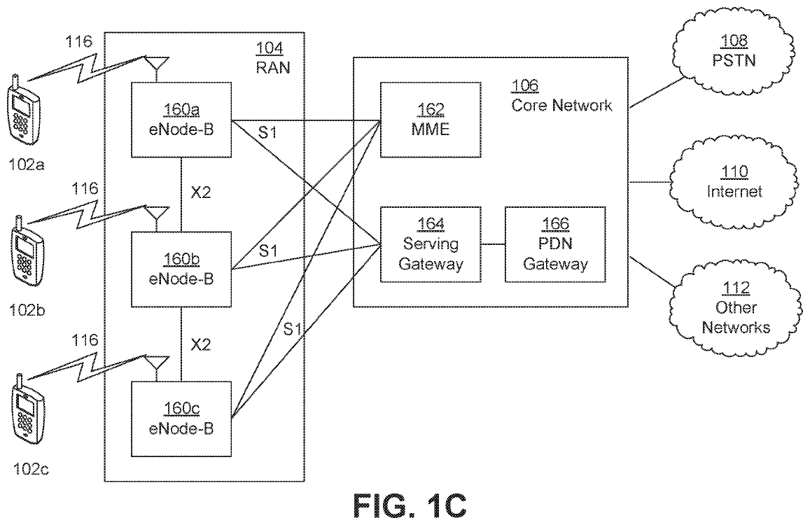

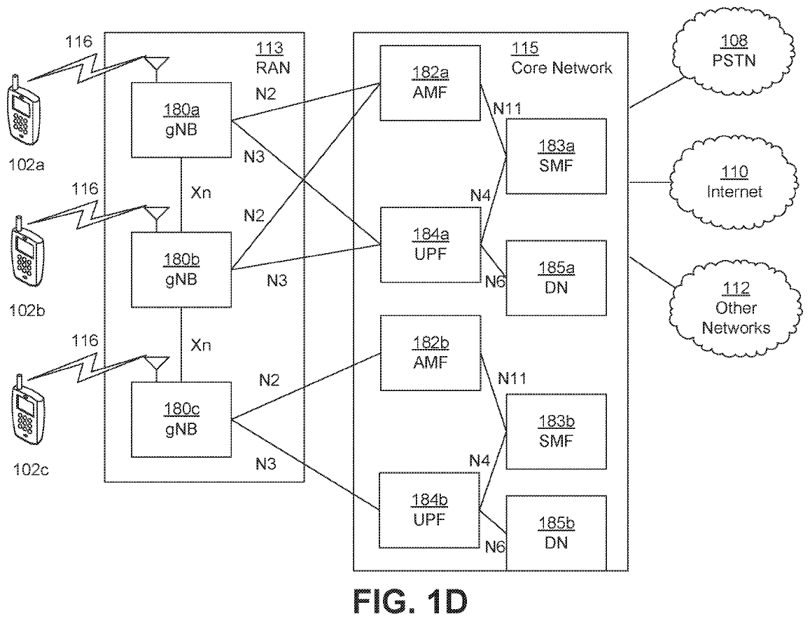

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tall unique-word DFT-Spread OFDM (ZT UW DTS-s OFDM), unique word OFDM (UW-OFDM), resource block-filtered OFDM, filter bank multicarrier (FBMC), and the like, As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-FI device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like, Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WIMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802. 15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like, The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WIFI radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like, The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram Illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter—9- eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS), In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115,

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

The following abbreviations and acronyms are used herein:
AC Application Client
AMF Access and Mobility Management Function
API Application Programing Interface
BSF Binding Support Function
DN Data Network
DNN Data Network Name
EAS Edge Application Server
ECS Edge Configuration Server
EDN Edge Data Network
EEC Edge Enabler Client
EEL Edge Enabler Layer
EES Edge Enabler Server
LADN Local Area Data Network
PLMN Public Land Mobile Network
SCP Service Continuity Planning
TA Tracking Area
UE User Equipment
URI Uniform Resource Identifier

Systems, methods, devices, and instrumentalities are described herein relating to authorizing a consumer when resolving an IP address.

A device (e.g., binding support function (BSF) may include a processor configured to perform one or more actions. The device may receive a request for a wireless transmit/receive unit (WTRU) identifier. The request may include a provided hash value and an IP address. The device may determine a calculated hash value based on the IP address. The device may determine that the provided hash value and the calculated hash value are not equal. Upon determining that the hash values are different, the device may send a response that includes an indication that the requested WTRU identifier is not included in the response.

The indication may indicate that the requested WTRU identifier is not included in the response because the provided hash value is not equal to the calculated hash value, The calculated hash value may be further based on one or more of the following: a subscription permanent identifier (SUPI), a data network name (DDN), a single-network slice selection assistance information (S-NSSAI), or a credential.

A device (e.g., a wireless transmit/receive unit (WTRU) may be configured to host an edge enabler client (EEC). The device may include a processor configured to perform one or more actions. The device may determine a provided hash value based on an IP address of the device. The device may send a request for a WTRU identifier. The request may include the provided hash value and the IP address. The device may receive a response. The response may indicate that the requested WTRU identifier is not included in the response.

The indication may indicate that the requested WTRU identifier is not included in the response because the provided hash value does not equal a calculated hash value.

The provided hash value may be based on one or more of the following: a subscription permanent identifier (SUPI), a data network name (DDN), a single-network slice selection assistance information (S-NSSAI), or a credential.

The processor of the device may be further configured to receive a first request to discover the WTRU identifier. The first request may be received from an application client.

An application layer for supporting edge services may comprise one or more of the following: an application client (AC), an edge application server (EAS), an edge enabler client (EEC), an edge enabler server (EES), an edge configuration server (ECS), a notification management client (NMC), or a notification management server (NMS).

Systems, methods, devices, and instrumentalities may be provided for hosting an edge enabler client (EEC). A security credential using an Internet Protocol (IP) address of the WTRU may be determined. A first message may be sent to a network node. The first message may indicate a request for a WTRU identifier, the security credential, and the IP address. A second message may be received from the network node. The second message may indicate the WTRU identifier based on the security credential.

In an example, the security credential may be a hash value.

In an example, determining the security credential using the IP address of the WTRU may comprise determining the security credential using the IP address and at least one of a subscription permanent identifier (SUPI) associated with the WTRU, a data network name (DDN) of a protocol data unit (PDU) session associated with the IP address, a single-network slice selection assistance information (S-NSSAI) of the PDU session, a credential associated with the EEC, or a credential associated with a binding support function (BSF).

In an example, determining the security credential using the IP address of the WTRU may comprise one or more actions. A secure connection to the network node may be established. A security parameter associated with the secure connection may be determined. The security parameter may be associated with the EEC and an edge enabler server (EES). The security credential using the IP address and the security parameter may be determined.

In an example, a third message may be received from an application client. The third message may indicate a request to discover the WTRU identifier. The first message may be sent to the network node based on the request to discover the WTRU identifier.

Systems, methods, devices, and instrumentalities may provide a binding support function (BSF). A first message from a second network node may be received. The first message may indicate a request for a wireless transmit/receive unit (WTRU) identifier, a first security credential, and an IP address. A second security credential may be determined based on the IP address. The first message may be determined to be secure if the first security credential matches the second security credential. A second message may be sent to the second network node if the first message is secure. The second message may indicate the WTRU identifier, and a response associated with the request for the WTRU identifier.

In an example, the first security credential may be a provided hash value. The second security credential may be a calculated hash value,

In an example, the first message may be determined to be an unsecured message if the first security credential is different from the second security credential.

In an example, a third message may be sent to the second network. The third message may indicate that the first security credential is different from the second security credential.

In an example, determining the second security credential using the IP address may comprise one or more actions. The second security credential may be determined using the IP address and at least one of a subscription permanent identifier (SUPI) associated with the WTRU, a data network name (DDN) of a protocol data unit (PDU) session associated with the IP address, a single-network slice selection assistance information (S-NSSAI) of the PDU session, a credential associated with the EEC, or a credential associated with a binding support function (BSF).

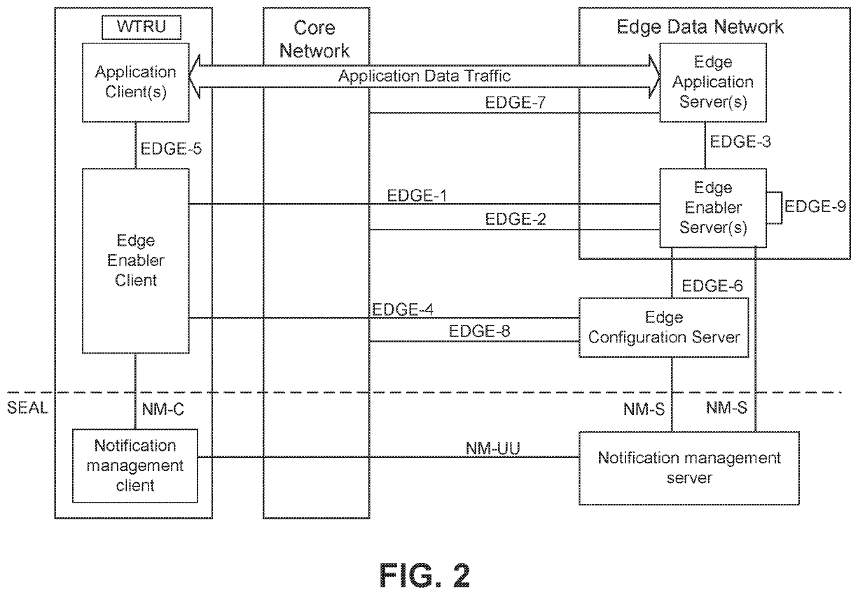

FIG. 2 depicts an example high-level architecture that may enable edge applications.

In examples, one or more of the following may be included in an example architecture that may enable edge applications.

An AC may be a user application residing on a WTRU that may communicate with an EAS. In an example, a WTRU may use one or more ACs concurrently.

An EAS may comprise an application server that may be resident in an edge data network (EDN). An EAS may comprise a software server that executes on hardware (e.g., a processor) that may be located at the edge and provides a service to the AC. One or more EAS instances may exist for an EDN (e.g., for each EDN). An EDN (e.g., each EDN) may contain a different set of EAS instances of different types (e.g., different EASID). An EAS may serve one or more AC instances that may reside on different WTRUs.

An EEC may provide edge support to an AC instance on a WTRU. One or more EEC may exist on a WTRU (e.g., for each WTRU). An AC may use one EEC.

An EES may provide one or more supporting functions that may be used (e.g., may be needed) by the EAS and EEC. In examples (e.g., in the context of mobility and relocation), a Source-EES (S-EES) may be an EES used before movement occurs, and a target-EES (T-EES) may be an EES that may be used if/when movement has occurred. One or more EES instances may exist for an EDN (e.g., for each EDN) and/or for a data network name (DNN) (e.g., for each DNN). One or more EDN instances may exist in a network (e.g., each network).

An ECS may provide one or more supporting functions for an EEC or EES to discover EES instances that may provide certain EAS. One or more ECS may exist for a network (e.g., each network).

An NMC may provide one or more supporting functions for an EEC that may create a notification channel between the NMC and an NMS to receive notifications from an ECS or EES. An EEC (e.g., each EEC) may use one NMC.

An NMS may provide one or more supporting functions for an ECS or EES. It may be possible that one ECS or EES may send one or more notifications to an EEC via a notification channel created between an NMC and the NMS. One or more NMS may exist for a network (e.g., each network).

A NAT IP address security concern may be addressed. A WTRU Identifier API may accept an EEC as a consumer of a service, The EEC may provide user information (e.g., a private WTRU IP address) to invoke this API.

Feature(s) associated with the use of WTRU provided information (e.g., to improve security) when invoking network-offered services (e.g., Nnef_UEId_Get) are provided herein.

In examples, one or more of the following may be performed. An EEC may send a request to an EES that may ask the EES to resolve an IP Address to a WTRU ID. The EEC may (e.g., only) be permitted to resolve its IP Address to a WTRU ID. The network may verify that an IP Address provided by the EES may be an IP Address that is assigned to the WTRU that hosts the EEC to determine (e.g., verify) if information (e.g., a WTRU IP address) provided by the EEC may be trusted.

In examples, verification of information provided by an EEC may improve security. For example, a malicious EEC of a first WTRU may Impersonate the EEC of a second WTRU by providing the second WTRU's IP address to obtain the WTRU ID of the second WTRU (e.g., by invoking the Nnef_UEId_Get API). A malicious EEC may scan for CN information (e.g., WTRU IDs) from the EES and/or NEF and obtain information the malicious EEC may not be authorized to access, which may compromise user privacy and/or security.

An IP address that may be provided by the EEC to the EES in an API call (e.g., Nnef_UEId_Get). The IP address may be a private IP Address of a WTRU that hosts the EEC. Because the EES and WTRU may communicate across a NAT function, the EES may not be able to verify the IP Address of the WTRU by inspecting the source IP Address of traffic from the EEC.

Feature(s) associated with credential derivation (e.g., a credential shared between an EEC and binding support function (BSF)) are provided herein. A credential that may be shared between an EEC and a BSF. The credential may be derived after an EEC and an EES perform an authentication (e.g., authorization) process and establish secure communication (e.g., between the two). In examples, a credential may be used to protect an EEC local IP address by calculating and verifying a hash when the EEC invokes the API to get a WTRU ID from an EES (e.g., to prevent the EEC local IP address from being impersonated). A hash calculation may include one or more parameters associated with a WTRU IP address, subscription permanent identifier (SUPI) of the WTRU, and/or other PDU session parameters. The PDU session parameters may include the DNN of a packet data unit (PDU) session, the single-network slice selection assistance information (S-NSSAI) of the PDU session, and the like. The PDU session may be the PDU session that the IP address may be associated with.

The EES may determine (e.g., verify) that an IP address received from an EEC (e.g., Nnef_UEId_Get API call) is associated with a SUPI, DNN, and/or the S-NSSAI by verifying a hash. A WTRU ID requested from the UDM may not be associated with an IP address used in an API invocation (e.g., Nnef_UEId_Get) until the hash is verified.

The following terms may be used interchangeably herein: generic public subscription identifier (GPSI), WTRU ID, External ID, and mobile subscriber ISDN number (MSISDN).

Feature(s) associated with calculating and verifying a hash from an IP address and a credential are provided herein. For example, verification may be achieved using a hash calculation (e.g., based on the shared credential).

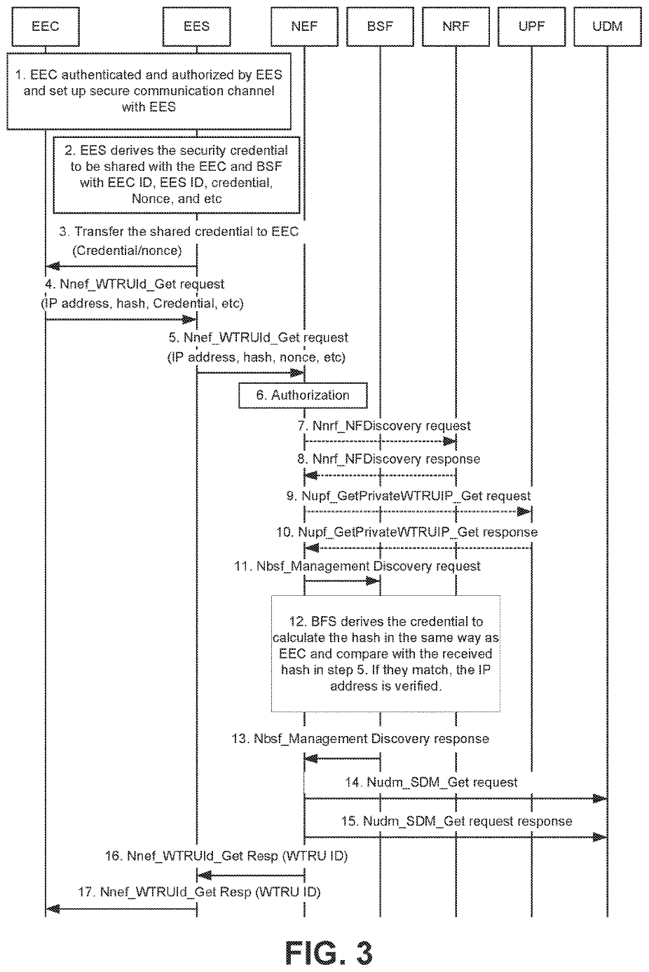

A system (e.g., a 5G system) may verify that a request to obtain a WTRU ID may be authorized. The verification may occur when an EEC requests that the network resolves an IP Address to a WTRU ID. A verification procedure, the procedure shown in FIG. 3, may allow a system to verify that an EEC's request for a WTRU identifier originated from an authorized entity. In examples, one or more of the following may be performed. An EEC and a BSF may perform a hash calculation. A WTRU's IP Address may be an input to the hash calculation. One or more additional inputs to the hash calculation may be a value known to the WTRU that hosts the EEC and the BSF, The one or more additional inputs to the hash calculation may be a value not easily known or determined by entities other than the WTRU that hosts the EEC). For example, the SUPI of the WTRU is a value that could be an input to the hash calculation and is a value that may not be easily known or determined by an entity other than the WTRU. For example, other WTRUs and network servers cannot easily determine the SUPI of the WTRU, and network servers cannot easily determine the SUPI of the WTRU since the SUPI of the WTRU is stored in the UDR and in the SIM card of the WTRU. The BSF may compare a result of the BSF's calculation and the hash value that was provided by the EEC of the WTRU when the BSF may be requested to provide information about the WTRU (e.g., the SUPI of the WTRU). The BSF may authorize a request following a determination (e.g., comparison) between the result of the BSF's calculation and the hash value that was provided by the EEC of the WTRU (e.g., the values are the same). The BSF may not authorize (e.g., deny) a request if the result of the BSF's calculation and the hash value that was provided by the EEC of the WTRU are not the same.

The SUPI may be a subscription identifier. A SUPI may be in the format of an international mobile subscriber identity (IMSI). Avoiding or minimizing exposing the SUPI may be requested (e.g., desired) to improve the security of a system (e.g., a 5G system). Avoiding or minimizing exposure of the SUPI may be a security principle of the system, such as the 5G System. The SUPI may be exposed by sending the SUPI in an API call and/or a message. The SUPI may be exposed by sending the SUPI to a logic entity that does not otherwise need the SUPI.

In examples, one or more of the following may be performed. In a WTRU, the SUPI may be stored in an integrated circuit (e.g., a SIM card). Calculating a hash based on the SUPI and other values (e.g., an IP address and one or more credentials) may be performed in the integrated circuit (e.g., SIM card). When calculating the hash, the terminal equipment (TE) part of the WTRU may send the IP address to the integrated circuit (e.g., SIM Card). The integrated circuit (e.g., SIM Card) may calculate the hash value without exposing the SUPI or credential to a mobile terminal (MT) part of the WTRU during the operation. Since the SUPI may be stored in the BSF (e.g., with an IP address and credentials that are associated with the WTRU), the BSF may check the validity of a hash value (e.g., relative to the SUPI and IP address).

FIG. 3 depicts an of example IP address verification that may use a shared credential between an EEC and an EES. The operations, as described with reference to FIGS. 3-5, may be performed in any order and/or simultaneously. In examples, one or more of the following may be performed.

An EEC may request an authorization token from an ECS. For example, prior to 1, an EEC may request the authorization token from the ECS. The token may be used by an EES to authorize the EEC to use the EES service.

At 1, the EEC may perform an authentication and authorization between the EEC and EES (e.g., to establish secure communication between the EEC and the EES).

At 2, the EES may generate a credential using one or more security parameters used for the secure session. For example, the EES may use an EEC ID; an EES ID; a nonce, such as a time stamp; and the like. The credential may be used between the EEC and EES. For example, the credential may be used between the EEC and a core network (e.g., the 5GC).

At 3, the credential may be sent to the EEC, and it may be used in the future, for example, for verification during API invocation(s). The EES may generate a nonce and/or send a nonce to the EEC.

When the EEC receives the nonce, the EEC may derive a shared credential between the EEC and EES (e.g., in the same fashion with identical inputs).

At 4, when the EEC may be triggered by the AC to get the WTRU ID, the EEC may invoke an API call (e.g., Nnef_UEId_Get) that may comprise getting (e.g., receiving, requesting, pulling) the WTRU ID from the EES. The request from the EEC may comprise the IP address, the credential (e.g., the shared credential generated at 3, received at 3 from the EES, or configured in the WTRU's integrated circuit), and/or other parameters (e.g., those specified in the API). The request may comprise an IP address. The request may be to retrieve a WTRU ID associated with the IP address. The credential (e.g., shared credential) may be a credential associated with the WTRU's SUPI.

The request (e.g., from the EEC) may comprise a hash value. The EEC may determine a hash value by performing calculations. The calculation may use one or more of the following as input: the private IP Address of the WTRU or the public IP address of the WTRU and a port number that may be used by the WTRU; the SUPI of the WTRU; the DNN of the PDU Session that the IP Address may be associated with; the S-NSSAI of the PDU Session that the IP Address may be associated with; or a credential that may be shared between the EEC and BSF. In examples, a credential that may be shared between the EEC and BSF may be derived by the EES and may be provided to the EEC and BSF.

At 5, the EES may receive the request from the EEC. The EES may act as an AF and invoke a request service (e.g., Nnef_UEId_Get request service of the NEF). The EES may provide an IP address that was provided by the EES as an input to the request service invocation (e.g., Nnef_UEId_Get). The request (e.g., Nnef_UEId_Get) may be enhanced (e.g., to Include a hash value that was received from the EEC as an input).

At 6, the NEF may authorize the AF request. If the authorization is not granted, the NEF may reply to the EES with a failure indication (e.g., a Result value indicating authorization failure). If the authorization may be granted, the NEF may perform one or more of the following. The NEF may determine corresponding DNN and/or S-NSSAI information. DNN and/or S-NSSAI information may be provided by the EES or determined by the NEF (e.g., based on the requesting EES Identifier and EES Provider Information).

The NEF may receive a port number at 5. The NEF may determine or recognize the address that is received may be an IP address that differs from the private WTRU IP address, which may have been assigned by the system. For example, the NEF may use a configuration to determine that the address received differs from the private WTRU IP address. The NEF may determine that the WTRU is behind a NAT if the address received differs from the private WTRU IP address. If the NEF determines the received IP address differs from the private WTRU IP address assigned, the NEF may perform the procedures shown in 7 through 10. If the NEF determines that the received IP address is the same or similar to the private WTRU IP address, the NEF may skip or may not perform the procedures shown in 7 through 10.

At 7, the NEF may use a service operation (e.g., a Nnrf_NFDiscovery service operation) to obtain the address of a UPF implementing NAT functionality for the WTRU (e.g., public) IP address. The request may comprise the WTRU (e.g., public) IP address. The NEF may also include the DNN and/or S-NSSAI associated with the AF ID, and/or the IP domain.

At 8, the NRF may respond with a response message (e.g., a Nnrf_NFDiscovery response message) that may include the UPF address of the UPF implementing NAT functionality for the WTRU (e.g., public) IP address.

At 9, the NEF may use a service operation (e.g., a Nupf_GetPrivateUEIP_Get service operation) to request a WTRU's (e.g., private) IP address from the UPF. The request may include the WTRU's (public) IP address and the WTRU Port Number. In examples, the request may include an IP domain, DNN, and/or S-NSSAI associated with the AF ID.

At 10, the UPF may respond with a response message (e.g., a Nupf_GetPrivateUEIP_Get response message) that may include the WTRU's IP address and/or the IP domain. If the UPF has applied a NAT functionality, the WTRU's IP address returned by the UPF may comprise the private WTRU IP address. If the IP domain of the WTRU private IP address is returned from UPF, it may take precedence (e.g., regardless of whether the IP domain information may be provided by AF, for example, when it invokes a Nnef_UEId_Get service operation).

At 11, when the NEF may invoke a service operation (e.g., a Nbsf_Management_Discovery service operation), the NEF may provide the hash value to the BSF (e.g., the service operation may be enhanced so that the NEF may include the hash value as an input). The inputs to the service operation (e.g., Nbsf_Management_Discovery) may comprise the IP address and hash value.

At 12, the BSF may determine the SUPI that is associated with the IP Address and may determine an expected hash value. The calculation that may be used to determine the expected hash value may be the same as the calculation that the EEC performs (e.g., at 4). When a PDU session (e.g., that may be associated with the IP address) is established, an SMF that serves the PDU session may select a PCF to serve the PDU Session. A selected PCF may invoke a service of the BSF to register with the BSF (e.g., for the PCF to inform the BSF that the PCF may be serving the PDU Session of the WTRU). The registration request from the PCF to the BSF may be used to send at least one of the WTRU's IP address(es), the WTRU's SUPI, a DNN that may be associated with the PDU Session, or the S-NSSAI that may be associated with the PDU Session to the BSF. A credential may be derived by the BSF (e.g., with the nonce received from the EES and/or other credential-deriving materials as may be used by the BSF to determine an expected hash value). The credential may be associated with the SUPI and may have been obtained by the PCF from the WTRU's subscription in the UDM/UDR or may be obtained from the SMF.

The BSF may compare the expected hash value and the hash value that was received in the service invocation (e.g., Nbsf_Management_Discovery).

At 13, if the received hash value and the expected hash value are the same, the BSF may respond to the NEF with a SUPI.

At 13, if the received hash value and the expected hash value are different, the BSF may respond to the NEF with an indication that the request is denied (e.g., because the IP Address may not be associated with the WTRU that made the request). If the request is denied, the verification process may be considered failed, and the procedures shown in 14 through 17 may be skipped.

At 14, the NEF may use the SUPI to query the UDM and may receive a GPSI from the UDM. The NEF may interact with the UDM to retrieve the AF-specific WTRU Identifier (e.g., via the Nudm_SDM_Get service operation). The request message may include the SUPI and may include one or more of the following: an application port ID, MTC provider information, or an AF identifier.

At 15, the UDM may respond to the NEF with an AF-specific WTRU Identifier represented as an external identifier for the WTRU (e.g., which may be uniquely associated with one or more of the application port ID, MTC provider information, and/or AF identifier).

At 16, the NEF may send the GPSI to the EES.

At 17, the EES may send the GPSI (WTRU ID) to the EEC.

Feature(s) associated with authorizing a WTRU ID request based on a hash calculation are provided herein.

In examples, one or more of the following may be performed by a BSF (e.g., to authorize a discovery request).

The BSF may receive a request to discover an identifier of a WTRU. The request to discover an identifier of a WTRU may include at least one of a provided hash value, a credential, an IP address, and/or the like.

The BSF may determine a calculated hash value. The calculated hash value may be determined based on an IP address (e.g., an IP address received in a request to discover an identifier of a WTRU) and one or more of a SUPI, a DDN, an S-NSSAI, or a credential.

The BSF may determine (e.g., check) if the calculated hash value and a provided hash value (e.g., a provided hash value received in a request to discover an identifier of a WTRU) are equal.

The BSF may (e.g., on the condition that the calculated hash value and a provided hash value are NOT equal) send a response message that indicates that a requested identifier is not included in the response. The response message may indicate that the requested identifier is not included in the response because a provided hash value (e.g., a provided hash value received in a request to discover an identifier of a WTRU) is not correct (e.g., is not equal to the calculated hash value).

In examples, one or more of the actions, such as the actions described herein, may be performed by an EEC (e.g., to obtain its WTRU identifier).

The EEC may receive a request to discover an Identifier of a WTRU. The request may be received from an application client.

The EEC may receive a credential and/or nonce (e.g., from the EES). In examples where the EEC may receive a nonce from the EES, the EEC may derive a credential (e.g., a shared credential between the EEC and the EES) in the same way as the EES. The EEC may determine a calculated hash value. The calculated hash value may be determined based on the IP address of the WTRU that hosts the EEC and one or more of a SUPI, a DDN, an S-NSSAI, or a credential.

The EEC may send a request to discover an identifier of a WTRU. The request to discover an identifier of a WTRU may include a provided hash value (e.g., a calculated hash value determined by the EEC) and/or the IP address.

The EEC may receive a response message that indicates that the requested identifier is not included in the response. The response message may indicate that the requested identifier is not included in the response (e.g., because the provided hash value included in the EEC's sent request to discover an identifier of a WTRU is not correct).

Features associated with calculating and verifying a hash from an IP address and credential are provided herein.

There may be a credential (e.g., a mandatory credential) shared between an EEC and an EES (e.g., for a WTRU ID API). The EEC local IP address may be bound with session information (e.g., DNN, S-NSSAI, and a shared credential) to secure an API.

In examples, one or more of the following may be performed by an EEC (e.g., to verify an IP address).

The EEC may send a request to an EES. The request may include an IP address. The request may be to retrieve a WTRU ID that may be associated with an IP address (e.g., the IP address included in the request). The request may include a hash value. The EEC may determine the hash value based on performing a calculation including one or more of the following as input: an IP address, a port number if available (e.g., if the IP address is a public IP address), the SUPI of the WTRU, the DNN of the PDU Session that may be associated with the IP address, the S-NSSAI of the PDU Session that may be associated with the IP address, a credential that may be shared between the EEC and the BSF (e.g., a credential that may be derived by the EES and EEC (e.g., when the EEC receives a nonce instead of the credential) and may be provided to the EEC (e.g., when a credential is received by the EEC from the EES) and the BSF), and the like.

The EES may receive the request from the EEC. The EES may act as an AF and invoke an API request (e.g., a UEId_Get request). The EES may provide the IP address of the EEC (e.g., an EEC residing on a WTRU) as an input to the request service invocation (e.g., Nnef_UEId_Get). The request (e.g., Nnef_UEId_Get) may be enhanced (e.g., the hash value that was received from the EEC may be included as an input).

When the NEF may invoke a service operation (e.g., the Nbsf_Management_Discovery), the NEF may provide the hash value and the nonce that may be used to derive the credential (e.g., in the same way as the credential was derived at the EEC) to the BSF (e.g., the Nbsf_Management_Discovery service operation may be enhanced so that the NEF may include the hash value as an input), The inputs to the service operation (e.g., Nbsf_Management_Discovery) may be the IP address, the credential, and/or the hash value.

The BSF may determine the SUPI that may be associated with the IP address, may derive the credential using the received nonce, and may determine an expected hash value. In examples, the calculation that may be used to determine the expected hash value may be the same as the calculation that the EEC performs.

The BSF may compare the expected hash value and the received hash value (e.g., the hash value that was received in the Nbsf_Management_Discovery service invocation).

If the received hash value and the expected hash value are different, the BSF may respond to the NEF with an indication that the request has been denied because the IP address (e.g., the received IP address) may be not associated with the WTRU that made the request.

If the received hash value and the expected hash value are the same, the BSF may respond to the NEF with a SUPI. The NEF may use the SUPI to query the UDM and may receive a GPSI from the UDM. The NEF may send the GPSI to the EES, and the EES may send the GPSI (e.g., WTRU ID) to the EEC.

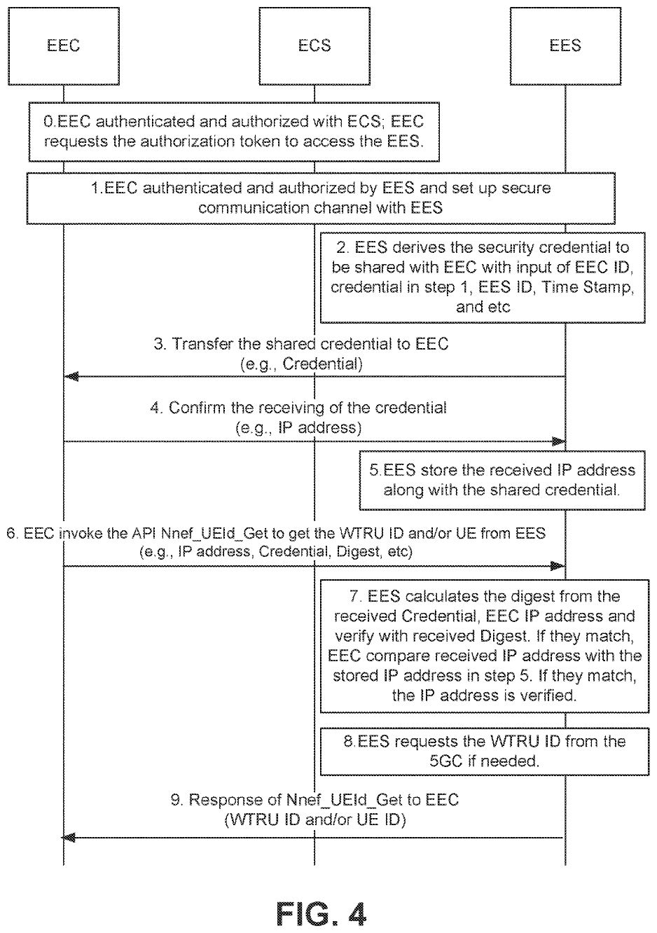

FIG. 4 depicts an example of IP address verification that may use a shared credential between an EEC and an EES.

At 0, the EEC may be authenticated and authorized with the ECS. The EEC may request the authorization token to access the EES.

At 1, the EEC may be authenticated and authorized by the EES. The EEC may set up a secure communication channel with the EES.

At 2, the EES may derive a security credential to be shared with the EEC. The security credential may be derived using at least one of the EEC ID, a credential (e.g., from 1), an EES ID, a timestamp, or the like.

At 3, the shared credential may be transferred from the EES to the EEC.

At 4, the EEC may confirm the receipt of the credential by sending its IP address to the EES. The IP address may be security protected using the shared credential.

At 5, the EES may store the received IP address along with the shared credential.

At 6, the EEC may obtain the WTRU ID (e.g., UE ID) from the EES, for example, by invoking the API Nnef_UEId_Get. The EEC may obtain the WTRU be sending a message, which my comprise at least one of an IP address, a credential, a digest, or the like.

At 7, the EES may calculate a digest using at least one of the received credential or an EEC IP address. The EES may verify the calculated digest with the received digest. If they match, the EEC may compare the received IP address with the stored IP address from 5. If they match, the IP address is verified.

At 8, the EES may request the WTRU ID from a network node (e.g., a core network node, 5GC, etc.).

At 9, the EES may send the response of Nnef_UEId_Get to the EEC, which may include the WTRU ID.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) for hosting an edge enabler client (EEC) comprising:
a processor configured to:
determine a security credential using an Internet Protocol (IP) address of the WTRU;
send a first message to a network node, wherein the first message indicates a request for a WTRU identifier, the security credential, and the IP address; and
receive a second message from the network node, wherein the second message indicates the WTRU identifier based on the security credential.

2. The WTRU of claim 1, wherein the security credential is a hash value.

3. The WTRU of claim 1, wherein the processor being configured to determine the security credential using the IP address of the WTRU comprises the processor being configured to determine the security credential using the IP address and at least one of a subscription permanent identifier (SUPI) associated with the WTRU, a data network name (DDN) of a protocol data unit (PDU) session associated with the IP address, a single-network slice selection assistance information (S-NSSAI) of the PDU session, a credential associated with the EEC, or a credential associated with a binding support function (BSF).

4. The WTRU of claim 1, wherein the processor being configured to determine the security credential using the IP address of the WTRU comprises the processor being configured to:
establish a secure connection to the network node;
determine a security parameter associated with the secure connection wherein the security parameter is associated with the EEC and an edge enabler server (EES); and
determine the security credential using the IP address and the security parameter.

5. The WTRU of claim 1, wherein the processor is further configured to receive a third message from an application client, wherein the third message indicates a request to discover the WTRU identifier.

6. The WTRU of claim 5, wherein the first message is sent to the network node based on the request to discover the WTRU identifier.

7. A first network node for providing a binding support function (BSF), the first network node comprising:
a processor configured to:
receive a first message from a second network node, wherein the first message indicates a request for a wireless transmit/receive unit (WTRU) identifier, a first security credential, and an IP address;
determine a second security credential based on the IP address;
determine that the first message is secure if the first security credential matches the second security credential; and
send a second message to the second network node if the first message is secure, wherein the second message indicates the WTRU identifier, and a response associated with the request for the WTRU identifier.

8. The first network node of claim 7, wherein the first security credential is a provided hash value, and wherein the second security credential is a calculated hash value.

9. The first network node of claim 7, wherein the processor is further configured to:
determine that the first message is an unsecured message if the first security credential is different from the second security credential; and
send a third message to the second network node, wherein the third message indicates that the first security credential is different from the second security credential.

10. The first network node of claim 7, wherein the processor being configured to determine the second security credential using the IP address comprises the processor being configured to determine the second security credential using the IP address and at least one of a subscription permanent identifier (SUPI) associated with the WTRU, a data network name (DDN) of a protocol data unit (PDU) session associated with the IP address, a single-network slice selection assistance information (S-NSSAI) of the PDU session, a credential associated with an edge enabler client (EEC), or a credential associated with a binding support function (BSF).

11. A method performed by a wireless transmit/receive unit (WTRU) for hosting an edge enabler client (EEC) comprising:
determining a security credential using an Internet Protocol (IP) address of the WTRU;
sending a first message to a network node, wherein the first message indicates a request for a WTRU identifier, the security credential, and the IP address; and
receiving a second message from the network node, wherein the second message indicates the WTRU identifier based on the security credential.

12. The method of claim 11, wherein the security credential is a hash value.

13. The method of claim 11, wherein determining the security credential using the IP address of the WTRU comprises determining the security credential using the IP address and at least one of a subscription permanent identifier (SUPI) associated with the WTRU, a data network name (DDN) of a protocol data unit (PDU) session associated with the IP address, a single-network slice selection assistance information (S-NSSAI) of the PDU session, a credential associated with the EEC, or a credential associated with a binding support function (BSF).

14. The method of claim 11, wherein determining the security credential using the IP address of the WTRU comprises:
establishing a secure connection to the network node;
determining a security parameter associated with the secure connection wherein the security parameter is associated with the EEC and an edge enabler server (EES); and
determining the security credential using the IP address and the security parameter.

15. The method of claim 11, wherein the method further comprises receiving a third message from an application client, wherein the third message indicates a request to discover the WTRU identifier.

16. The method of claim 15, wherein the first message is sent to the network node based on the request to discover the WTRU identifier.

17-20. (canceled)
